(19) United States
(12) Patent Application Publication
(10) Pub. No.: US 2018/0247078 A1
(43) Pub. Date: Aug. 30, 2018

(54) SYSTEM FOR ANONYMIZATION AND FILTERING OF DATA

(71) Applicant: Gould & Ratner LLP, Chicago, IL (US)

(72) Inventor: David Newman, Highland Park, IL (US)

(21) Appl. No.: 15/906,462

(22) Filed: Feb. 27, 2018

Related U.S. Application Data
(60) Provisional application No. 62/464,453, filed on Feb. 28, 2017.

(51) Int. Cl. G06F 21/62; G06Q 50/18; G06F 17/30; G06F 17/27

(52) U.S. Cl. CPC G06F 21/6254; G06Q 50/184; G06F 17/277; G06F 17/30699; G06F 17/30011

(57) ABSTRACT

An information-retrieval system includes a server that manages document retrieval, anonymizes data, receives queries for documents from client devices and means for outputting results of queries to the client devices, with the results provided in association with one or more interactive controls and filters that are selectable to invoke display of masked information and related professionals, referenced in the results.

### CROSS-REFERENCES TO RELATED APPLICATIONS

This application claims priority from U.S. Application No. 62/464,453, filed Feb. 28, 2017, incorporated by reference in its entirety.

### TECHNICAL FIELD

The present application relates to anonymization and filtering of document data containing confidential information. The anonymization may include data masking, de-identifying, randomizing and synthetic data creation. In an embodiment, the anonymization is applied to documents such as license agreements that contain sensitive information including licensor or licensee name or patent number. The filtering system may be applied to litigation data and match attorney credentials with litigation subject matter.

### BACKGROUND OF THE INVENTION

Privacy concerns are prevalent with respect to medical data due to HIPPA laws. Methodologies have been developed to anonymize sensitive information from medical data so that researchers may study large groups of data in order to analyze outcomes and levels of treatment success or failure. High risk attributes may be removed from data sets including name, social security number, address, medical condition, date of birth, gender, race or zip code. While such attributes present privacy challenges in the medical field that have been resolved through traditional anonymization methodologies, such tools have not been adopted in other fields.

For example, business data records may include sensitive information such as monetary data including sales prices, profit margins, trading margins or frequency. Also, in the area of intellectual property there is sensitive data included in licenses including licensee name, licensor name, patent number, trademark registration number or copyright registration number. The present invention provides new methodologies for handling sensitive information regarding intellectual property transactions.

Previous methods to collect licensing data have been inefficient and provide inadequate valuation methods. FIG. 1 depicts a prior art system for valuation of patents. The system is based mainly upon a hypothetical negotiation paradigm established by Judge Tenney of the Southern District of New York in Georgia-Pacific v. U.S. Phywood Corp, 318 F Supp 1116, 1120 (S.D.N.Y. 1970). To apply the 15 Georgia Pacific factors and establish facts of the hypothetical negotiation usually requires a patentee to hire an expert to conduct the valuation. Data can also be obtained from public SEC records containing reasonable royalty rate data. Such databases typically contain 10,000 or less total licenses spread across all technology areas with such data collected, a valuation expert undertakes the difficult and time consuming effort to apply the 15 Georgia Pacific factors 1-15 (FIG. 1 in order to arrive at a hypothetical value or royalty rate 16 for the asserted patent(s) The Georgia Pacific factors are.
1. “The royalties received by the patentee for the licensing of the patent in suit, proving or tending to prove an established royalty.
2. The rates paid by the licensee for the use of other patents comparable to the patent in suit.
3. The nature and scope of the license, as exclusive or non-exclusive; or as restricted or non-restricted in terms of territory or with respect to whom the manufactured product may be sold.
4. The licensor's established policy and marketing program to maintain his patent monopoly by not licensing others to use the invention or by granting licenses under special conditions designed to preserve that monopoly.
5. The commercial relationship between the licensor and licensee, such as, whether they are competitors in the same territory in the same line of business; or whether they are inventor and promoter.
6. The effect of selling the patented specialty in promoting sales of other products of the licensee; the existing value of the invention to the licensor as a generator of sales of his non-patented items; and the extent of such derivative or convoyed sales.
7. The duration of the patent and the term of the license.
8. The established profitability of the product made under the patent, its commercial success; and its current popularity.
9. The utility and advantages of the patent property over the old modes or devices, if any, that had been used for working out similar results.
10. The nature of the patented invention, the character of the commercial embodiment of it as owned and produced by the licensor and the benefits to those who have used the invention.
11. The extent to which the infringer has made use of the invention, and any evidence probative of the value of that use.
12. The portion of the profit or of the selling price that may be customary in the particular business or in comparable businesses to allow for the use of the invention or analogous inventions.
13. The portion of the realizable profit that should be credited to the invention as distinguished from non-patented elements, the manufacturing process, business risks, or significant features or improvements added by the infringer.
14. The opinion testimony of qualified experts.
15. The amount that a licensor (such as the patentee) and a licensee (such as the infringer) would have agreed upon (at the time the infringement began) if both had been reasonably and voluntarily trying to reach an agreement; that is, the amount that a prudent licensee—who desired, as a business proposition, to obtain a license to manufacture and sell a particular article embodying the patented invention—would have been willing to pay as a royalty and yet be able to make a reasonable profit and which amount would have been acceptable by a prudent patentee who was willing to grant a license.

The use of the Georgia Pacific factors is usually very expensive and has been criticized by many IP practitioners and judges. A more streamlined valuation system is needed to establish a more efficient technology transfer, valuation system and IP marketplace.

Data systems exist that analyze documents based on the types of legal proceedings, legal documents and names of people in the documents. For example. West Publishing Company provides thousands of electronic judicial opinions and links the names of judges and attorneys to their online biographical entries in the West Legal Directory. This directory provides a directory of approximately 20,000 judges and 1,000,000 U.S. attorneys and allows users to obtain contact information about lawyers and judges named in the opinions and access judicial opinions.

The West directory uses this information to determine whether to link the named attorneys and judges to their corresponding entries in a directory. Additional need for improvement in these and other systems to generate further automatic links and matching attorneys to newly filed proceedings and anonymizing data is desired.

### BRIEF DESCRIPTION OF DRAWINGS

FIG. 1 is a flow diagram depicting a prior art system for valuing patents;

FIG. 2 is a flow diagram depicting the present invention for a streamlined valuation system;

FIG. 3 is a flow diagram depicting the collection of licensing data of the present invention;

FIG. 4 is a diagram of an exemplary information-retrieval system corresponding to one or more embodiments of the invention;

FIG. 5 is a flow diagram corresponding to one or more exemplary methods of operating the system for anonymizing data;

FIG. 6 is a flow diagram corresponding to one or more embodiments of the invention for matching a counsel's credentials with a subject matter of a litigation for a defendant; and

FIG. 7 is flow diagram corresponding to an exemplary embodiment of the invention that establishes a patent value index score.

This description references and incorporates the above-identified Figures, describes one or more specific embodiments of the invention that are offered only to exemplify the invention and are shown and described in sufficient detail to enable those skilled in the art to implement or practice the invention.

### SUMMARY

The invention provides a system for anonymizing license data comprising a first database including a set of records, a parser module to identify one or more lexical elements contained within a license document, a comparison module adapted to compare a first category reference against the lexical elements and an extraction module adapted to extract the first category reference from the document based at least in part on the lexical elements wherein the first category reference contains sensitive license information.

The invention may provide the first category reference comprising sensitive license information including one or more of patent number, assignee name, inventor name and owner name. The invention may provide the set of records include one or more of legal records from PACER, Linked-In or licensing records from licensing organizations.

The invention may provide an extraction engine for collecting ranking information from one of the following categories including exclusivity clause in license, enforceability clause in license, entanglements issues, royalty rate, royalty calculation clause, auditing clause, hot technology sector, payment of annuity, patent expiration, patented portion, SEO, lump sum payment, licensing as a result of litigation, size of licensor/ee, FRAND commitment applied, minimum annual royalty required, and first office action allowance. The ranking is applied in a manner to identify the strength of a patent license, strength of a patent or the most flexibility for generation of maximum royalties using a numeric scale assigned to sub-categories.

The sub-categories include one of an exclusivity clause: no clause, exclusive, some portion is exclusive, non-exclusive; enforceability clause: no termination clause, termination clause but no right to sue, termination clause and clear definition of licensed product to allow for right to sue, termination clause and liquidated damages clause and clear definition of licensed product; entanglements: Standard Essential Patent (SEP) or lacking clear definition of SEP, SEP under Standard Setting Organization (SSO) rules with strict enforcement policy, SEP under SSO with lenient enforcement policy, non-SEP; Royalty calculation: no clause, capped total royalty payment, one-time payment, percentage rate or unit rate for life of patent; royalty: no royalty or unit rate, rate is under 3%, rate is 3-10%, rate is higher than 10%; auditing capability: no auditing clause, audit solely invoices, audit all books and records, audit all books and records and certified financial statements; granularity of field of use definition: no field of use definition, loose definition; detailed definition; definition tracks claims of majority of patents; hot technology: unrated technology, technology sector included in bottom third of NASDAQ composite companies, technology sector included in middle third of NASDAQ composite companies, technology sector included in top third of NASDAQ composite companies; patentee investment in patent: 1^{st} Office Action allowance, patent granted after request for continued examination, patent granted after appeal, paid 1^{st} annuity (small entities only), paid 2^{nd} annuity (small entity only), paid 3^{rd} annuity (small entity only), filed counterparts in at least 5 foreign countries (small entity only).

The ranking may be provided as a percent rank. The anonymization may include one of database anonymization, database sanitization, masking, synthetic data, Statistical Disclosure Control (SDC), Statistical Disclosure Limitation (SDL), Privacy Preserving Data Publishing (PPDP), Privacy Preserving Data Mining (PPDM), microdata anonymization, perturbative masking, non-perturbative masking, threshold-based record linkage, rule-based record linkage, probabilistic record linkage, data de-identification, k-Anonymity modeling, t-Closeness microaggregation, calibration to sensitivity and multivariate microaggregation and individual ranking microaggregation.

The invention may provide a selection system comprising a biographical parsing engine and a biographical database set of records, the system comprising a means for parsing content of a document to identify one or more lexical elements determined to be indicators of target entity data, means for extracting a first set of the target entity data from the document based at least in part on the lexical elements, means for comparing the first set of target entity data against a biographical database set of records, means for determining whether one or more of the target entity data match one or more records from the set of biographical database set of records and means for merging matching records from the target entity data and the set of biographical database and generating a set of merged matching records.

The invention may provide means for updating the set of biographical database with target entity markers related to target entity data and providing links associated with a set of records from the biographical database set of records. The invention may provide means for delivering information related to the merged matching records to a defendant listed in the document. The biographical database may relate to individuals considered to be expert within at least one of the following fields: legal, dispute resolution, financial, accounting, engineering, healthcare, medical, scientific, research and educational. The invention may provide a document including a legal complaint and the target entity data including one of lexical elements relating to one of a technology, jurisdiction and judge.

The legal complaint may include a count for patent infringement and the lexical elements include technical terminology from the asserted patent. The lexical element may include the patent classification code from a patent listed in the legal complaint. The parsing engine may include a server comprising means for receiving updates of documents and automatically running queries for lexical elements and automatically outputting results of queries to client devices, with the results provided in association with one or more matching target entity data.

One or more of the recited means may include one or more processors, computer-readable medium, display devices, and network communications, with the machine-readable medium including coded instructions and data structures. The invention may provide the document in anonymized form with respect to sensitive data. The biographical database set of records includes one or more of a professional directory, a legal professional directory, a medical professional directory, and an expert witness directory.

A method for anonymizing a document is provided comprising detecting a characterization label of an entity who is a party to a contested proceeding, obtaining a set of data comprising entities, each entity being associated with one or more features related to the entity and a characterization label indicating a characterization of the entity, the characterization labels comprising an operating company label and a patent monetizing entity label and using at least some of the one or more features of the entities and the characterization labels to train a classifier for predicting the characterization label of an entity in a contested proceeding; and using the label data to compare to law firm label data in order to identify law firms with matching label data. The lexical elements may include one or more of person's name, degree, area of expertise, organization, city, state, license, professional designations or certifications, title, work experience, university, patent number, inventor name, assignee name, technology category, classification number, filing date, issuance date, publication date and license information including number of patents, exclusivity, standard essentiality, scope and royalty rate.

A second category reference is provided comprising professional information including one or more of a person's name, title, license, degree, professional designation, work experience, court appearances, firm name. A first match code set is adapted to determine whether the second category reference matches any records contained in the set of harvested entity records and saving the matched records. Disclosing the matched records to defendants listed in a lawsuit.

The second category reference may include professional records associated with one or more of the following fields: type of legal dispute, judge name, court name, law firm name, financial result, motion results, trial experience, trial results, legal subcategory of pharmaceutical, accounting, engineering, healthcare, medical, scientific, and educational. The match code set includes executable instructions for performing one or more of a Bayesian function, a match probability function, and a name rarity function. One or both of the first and second match code sets may include executable instructions for satisfying a threshold match probability criteria prior to extraction. Code adapted to store extracted category references that do not match records contained in the home database set of records. The parsing engine for harvesting professional credentials that match first category references to lexical elements of professionals listed in notice section of document and disclosing credential information to defendant listed in newly filed complaint. The parsing engine may include code when executed adapted to compare a first category reference against previously stored harvested entity records.

The harvested entity may be associated with an expert profile and the categorizing is based on area of expertise and loading license data to a central file. Applying anonymizing tool to the licensing data to remove sensitive information from each license. Creating a counterpart synthetic license document having the sensitive data removed. Loading license data from each counterpart synthetic license to a relational database and enabling searching of predetermined fields of the license data. Creating a table containing tags is established to cross-reference each license and its counterpart. Anonymizing includes one of masking, de-identifying, obsfucating and randomizing the licensing data. Anonymizing step occurs on site at custodians location where the original licensing data resides. License data from a first custodian is combined in a database with license data from a second custodian. The counterpart license data is combined in a database with ranking data specific to the counterpart license. The director may anonymize the licensing data where the director applies a template in order to remove predetermined sensitive data including patent numbers, licensor name and address and licensee name and address. The custodian may provide a group of licenses categorized solely by technology segment. Counterpart licenses are collected according to a uniform protocol and the counterpart licensing data being entered as evidence to prove a reasonable royalty rate. The entropy of the original licensing data is measured to determine the risk of identity leakage. Conditional entropy H(Φ|Q) is calculated according to the equation: H(ΦQ)=−Σi=1VPc(i)·log 2Pc(i), wherein V is the number of possible values for user identity Φ and wherein P_{c}(i) is the posterior probability of identity value, given Q.

A method for anonymizing licensing data comprising the steps of loading license data to a central file, applying the anonymizing tool to the licensing data to remove sensitive information from each license, creating a counterpart synthetic license document having the sensitive data removed and loading license data from each counterpart synthetic license to a relational database and enabling searching of predetermined fields of the license data. A table containing tags is established to cross-reference each license and its counterpart. Anonymizing includes one of masking, de-identifying, obsfucating and randomizing the licensing data. The anonymizing step may occur on site at custodian's location where the original licensing data resides.

The license data from a first custodian is combined in a database with license data from a second custodian. The counterpart license data is combined in a database with ranking data specific to the counterpart license. A director may anonymize the licensing data where the director applies a template in order to remove predetermined sensitive data including patent numbers, licensor name and address and licensee name and address. The custodian may provide a group of licenses categorized solely by technology segment. Counterpart licenses may be collected according to a uniform protocol and the counterpart licensing data being entered as evidence to prove a reasonable royalty rate. The entropy of the original licensing data is measured to determine the risk of identity leakage. Conditional entropy H(Φ|Q) is calculated according to the equation: H(ΦQ)=−Σi=1VPc(i)·log 2Pc(i), wherein V is the number of possible values for user identity Φ and wherein P_{c}(i) is the posterior probability of identity value, given Q. The set Q includes a probabilistic attribute characterized by a probability distribution of possible values for the attribute. The user identity Φ is the sensitive licensing data from the license.

The set Q is determined to be an identity-leaking set if the level of anonymity is less than the anonymity threshold in order to remove the license from the group of licenses to be posted to the database. The numeric benchmark values may be derived by a percentile rank via the percent ranking module according to the following formula: PR=fb+12fwN*100 where PR is the percent rank; f_{b} is the frequency below the number of benchmarks which are less than the benchmark value percentile rank; f_{w} is the frequency within the number of benchmarks which have the same value as the benchmark value of the percentile rank; N is the number of benchmarks; and relative frequency is calculated according to the following formula: fb=niΣni where f_{b} is the frequency below the number of benchmarks which are less than the benchmark value percentile rank; and n is the number of benchmarks. The benchmark is determined with respect to the royalty rates of comparable licenses.

### DETAILED DESCRIPTION OF THE INVENTION

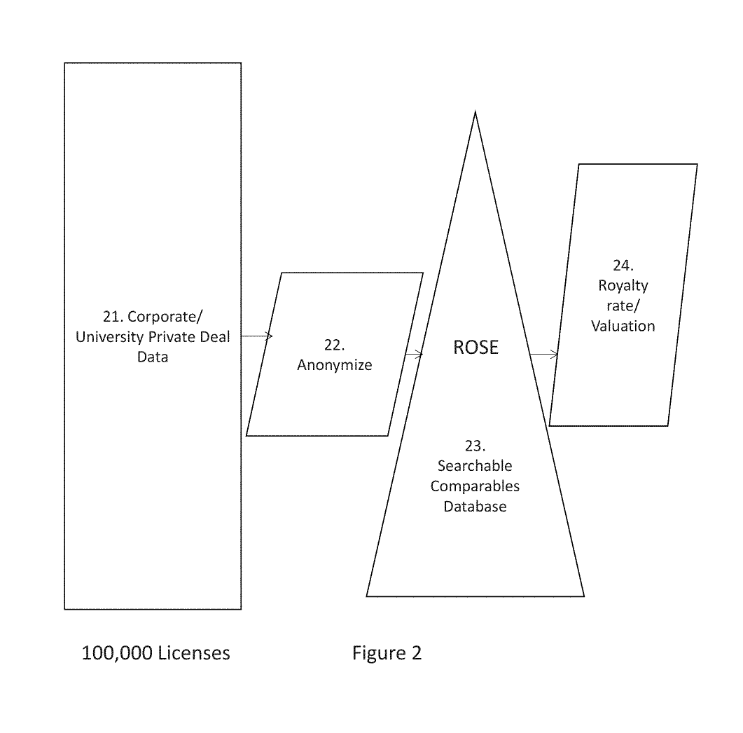

Embodiments of the present invention are depicted with respect to FIGS. 2-7. FIG. 2 is a schematic diagram of the valuation system of the present invention. The data to populate a valuation database is obtained in one example from private deal license data 21. This data may be collected from custodians such as corporations or universities. Hundreds of thousands of licenses have been executed by corporations and universities that have been held privately and shielded from public disclosure. Many of such licenses have confidentiality clauses that prevent the licenses from being disclosed publicly. However, the anonymization system 22 of the present invention can help to isolate valuation data from sensitive data from such licenses so that the valuation data can be used publicly to establish a robust database of comparable data. By first anonymizing the licenses in order to redact sensitive information such as licensor name, licensee name, patent number(s) and other identifying information the remaining valuation data can be used to populate a searchable database 23.

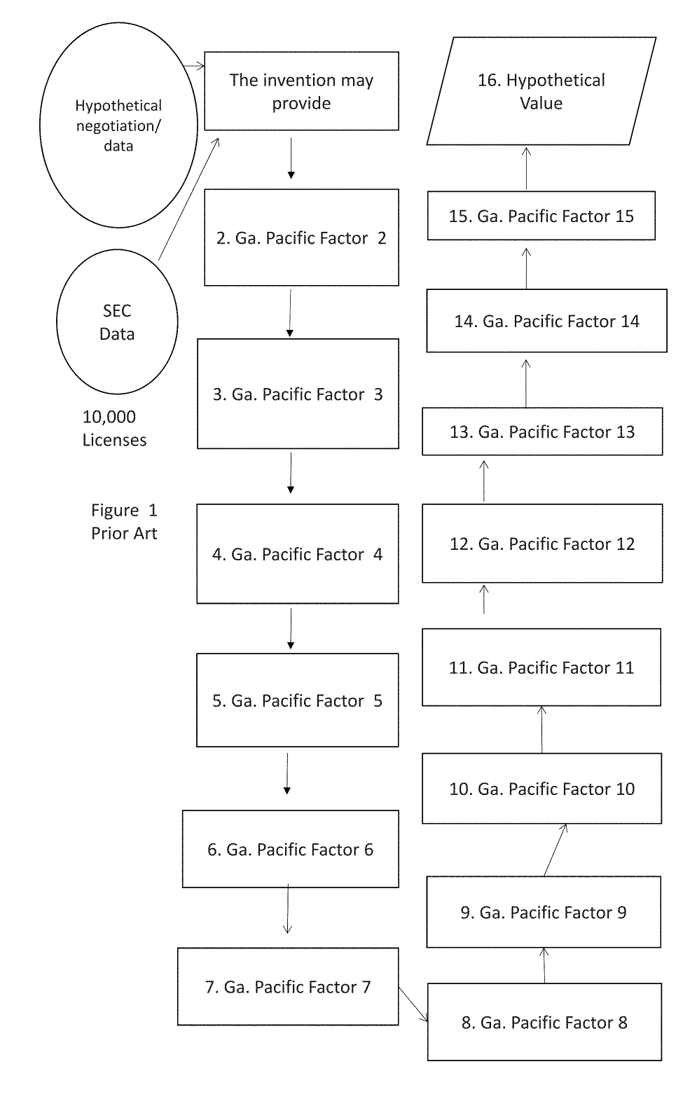

Once the searchable database 23 is fully populated with comparable license data a valuation process may be much more simplified than prior art systems as described above for example with respect to FIG. 1. In some cases, there would be no need to use the 15 Georgia Pacific factors. A patentee, licensor or licensee may use the database in order to quickly enter comparable data to obtain a value (much as the MLS for residential real estate valuations) or reasonable royalty rate. It may be understood that the present system opens up previously private licenses and provides a more transparent technology transfer marketplace. This royalty sunshine enterprise (ROSE) can help greatly lower licensing transaction and litigation costs.

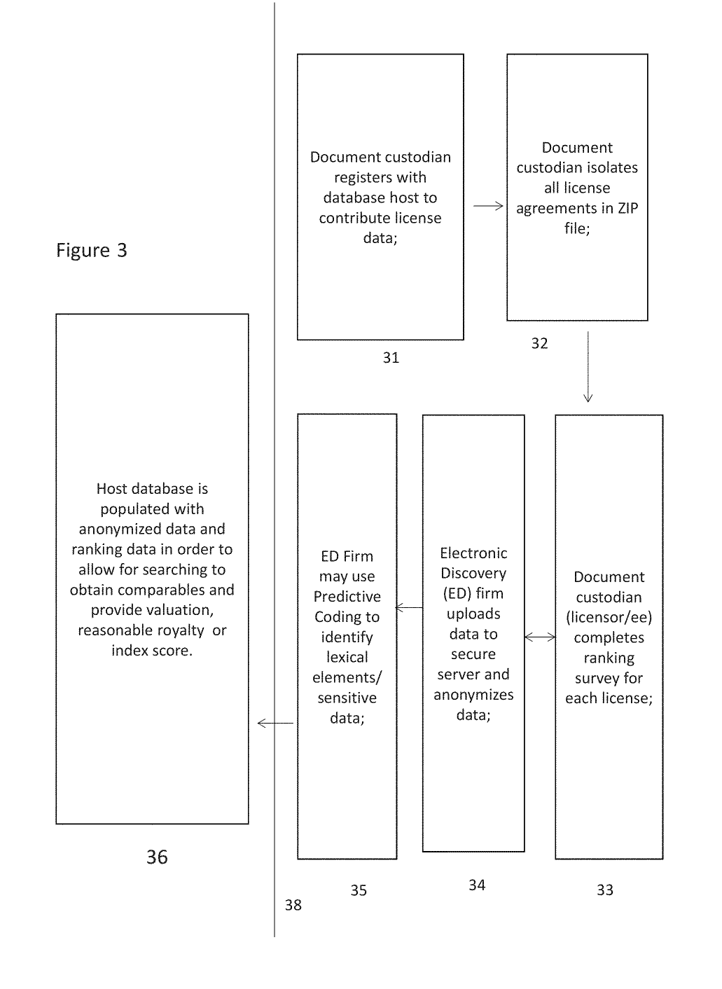

FIG. 3 depicts an exemplary embodiment for collection of license information from custodians. In the first step 31, the custodian of a license, such as a licensee or licensor can register with the database host and agree to the terms for disclosure of license data. For example, custodians should agree that its selection of licenses to contribute will not be undertaken in a biased or discriminatory manner. In a next step 32, the custodian (licensor or licensee) will isolate all pertinent license agreements and place them in a file, for example a ZIP file. In some circumstances, licenses relating to a certain technology category will be grouped together by the custodian and all such licenses relating to such technology area will be isolated by the custodian. Such collection of licenses can be accomplished entirely by the custodian, so that its internal security policies and procedures can be followed and no disclosure of sensitive information from the licenses leaves the custodian's custody. In an embodiment and the licensing information may be collected on a spreadsheet.

In the next step 33, the custodian has a questionnaire/survey completed that provides detailed information about the IP covered by the license agreements. The survey is used to provide ranking information regarding the license and IP of that license. In many cases, the IP professionals who negotiated the licensing deals or managed such licenses are most knowledgeable about the IP and can provide the most accurate information regarding the value or strength of such IP. The ranking categories are described in more detail below.

At the next step 34, the custodian or an outside vendor hired by the custodian will anonymize the isolated licenses. For example, many consultants who provide litigation support services, such as for electronic discovery and data collection are capable to anonymize data. Specific anonymization protocol will be established by the database host for the electronic discovery (ED) firm to follow, such as how to strip out patent numbers, licensor name, licensee name and addresses and other sensitive or identifying information. Further details regarding anonymization techniques are described below.

At the next step 35, the ED firm may use predictive coding to identify pertinent licensing terms and establish a new data set including the anonymized data for the host database. In an exemplary embodiment, the ED firm may conduct its work at the custodian's premises to avoid any security breaches. A firewall 38 represents the boundary of a customer's internal computer network.

At step 36, the ED firm transfers the anonymized data to the database host. It is understood that the license information being transferred at this time has no sensitive data included and such transfer should cause the custodian no risk of disclosure of confidential or sensitive information outside the firewall 38. Any identification of the custodian's identity will be communicated separately by the ED firm from the valuation data to the host of the database. The database host will populate its database with the anonymized valuation data. In an embodiment, the valuation data may be combined with the ranking data prepared at step 33.

The database is fully populated and subscribers may search the database in order to obtain comparable license terms by which it may establish a value or reasonable royalty rate for similar IP. The database may provide, as well, a patent value index score. It is understood that all parties involved including custodians will benefit from such a transparent system by establishing lower transaction costs for IP acquisition, IP licensing, IP taxation/valuation transactions and IP litigation.

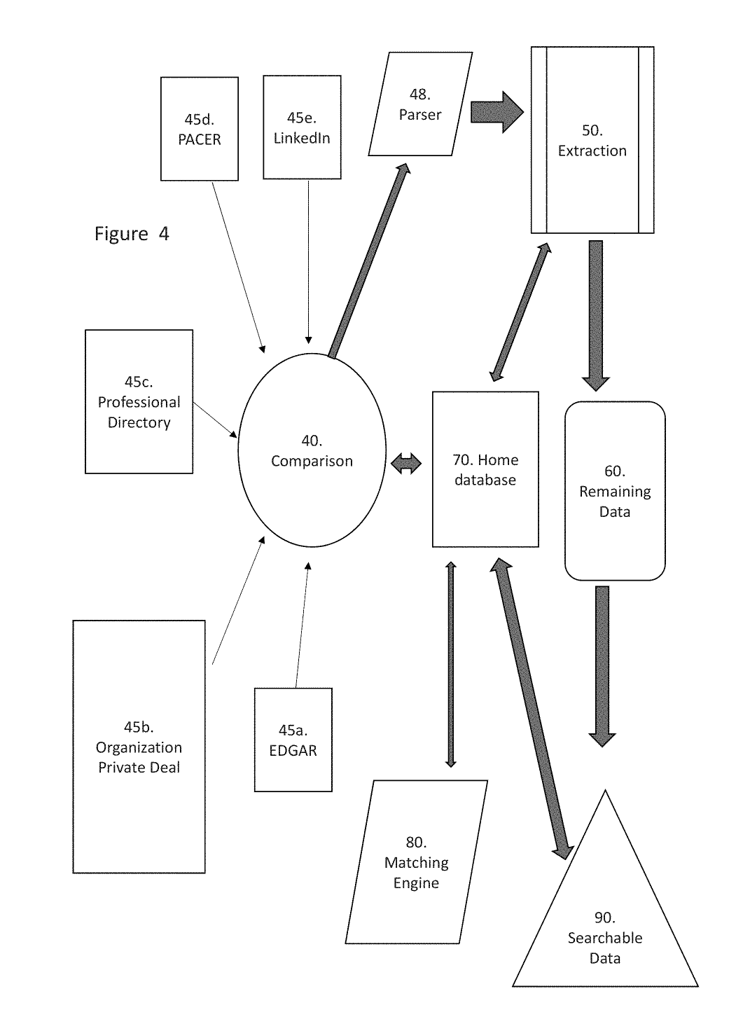

FIG. 4 shows an exemplary online information-retrieval system. The system includes one or more databases 45a-e, one or more servers 40-80 and one or more access devices such computers or mobile devices connected through a network, internet or intranet.

Databases 45a-e includes a set of one or more databases. In the exemplary embodiment, the set includes an EDGAR, Securities and Exchange database 45a, at least one database of an organization containing documents, such as license agreements and/or license agreement deal data from private deals 45b, such as from corporations, universities, small businesses and foundations. Also included are professional directories 45c such as from Martindale & Hubble or West including attorneys and experts. A caselaw database 45d, such as a verdict and settlement database, a court-filings database or consolidated caselaw database by PACER or other services such as Lex Machina/LexisNexis are provided. Other professional databases 45e are provided including LinkedIn and an expert witness directory.

Databases 45a-e generally include electronic text. ASCI or image copies of judicial opinions for decided cases for one or more local, state, federal, or international jurisdiction Professional and expert witness directories may be included within the caselaw database 45d, having one or more records, lexical elements or database structures. For example, a license agreement document from Private Deal database 45b, may contain a Notice clause that lists an attorney(s) to which Notices pertinent to the license deal should be notified.

Professional directories or biographical databases 45c include professional licensing data from one or more state, federal, or international licensing authorities. In the exemplary embodiment, this includes legal, medical, engineering, and scientific licensing or credentialing authorities. Caselaw database 45d includes verdict and settlement databases with assessed damages, or negotiated settlement of legal disputes associated with cases within caselaw database such as PACER 45d. Other databases such as articles databases having articles technical, medical, professional, scientific or other scholarly or authoritative journals and authoritative trade publications, patent publications. Caselaw database 45d includes electronic text and image copies of briefs, motions, complaints, pleadings, discovery matters, counsel, law firm and subject matter information. Other databases include news stories, business and finance, science and technology, medicine and bioinformatics, and intellectual property information. Logical relationship hueristics across documents are provided using automatic discovery processes that leverage information such as litigant identities, dates, jurisdictions, attorney identifies, court dockets, and so forth to determine the existence or likelihood of a relationship between any pair of documents.

Databases 45a-e may take the form of look-up tables, SQL databases provided by electronic, magnetic, or optical data-storage devices, include or are otherwise associated with respective indices. The databases 45a-e are coupled via a wireless or wired communications network, such as a local-, wide-, private-, or virtual-private network, to servers 40, 48, 50, 60, 70.

Servers 40-70 are generally representative of one or more servers for serving data in the form of webpages or other markup language forms with associated applets. ActiveX controls, remote-invocation objects, or other related software and data structures to service clients. The servers may comprise comparison server 40, parser server 48, extraction server 50, data server 60 and matching engine server 80 and each may include a processor, a memory, a subscriber database, one or more search engines and software modules. Each processor may be local or distributed or virtual machines that are coupled to memory.

Home database 70 includes a subscription based data base linked via a network server includes subscriber-related data for controlling, administering, and managing pay-as-you-go or subscription-based access of database 70. Database 70 includes subscriber-related data for controlling, administering, and managing pay-as-you-go or subscription-based access of databases 45a-e. Database and search engine 70 provides Boolean or natural-language search capabilities for databases 45a-e.

Search module 90 defines one or portions of a graphical user interface that helps users define searches for databases 45a-e, including software that includes one or more browser-compatible applets, webpage templates, user-interface elements, objects or control features or other programmatic objects or structures a search Interface and a results interface.

Servers 40-80 are communicatively coupled or couplable via a wireless or wired communications network, such as a Ethernet, local-, wide-, private-, or virtual-private network, to one or more accesses devices, such as access device, such as a personal computer, workstation, tablet, personal digital assistant, smart phone using I-OS, Android, Microsoft Windows operating system, and a browser such as Google or Microsoft Internet Explorer. Also included are query region having interactive control features, such as a query input portion for receiving user input at least partially defining a profile query and a query submission button for submitting the profile query to server 70, 80.

Comparison engine 40, parser engine 48, extraction engine 50, matching engine 80 receive search queries, includes results listing portion and a document display portion, a control feature for accessing or retrieving one or more corresponding search result documents, such as a license agreement having been anonymized or professional profile data and related documents, from one or more of databases 45a-e relating to newly filed lawsuits via server/search engine 70. Each category reference includes a respective document identifier or label, such as LIC 1 (License 1), LIC 2 (License 2) identifying respective technology category, subject-matter data or the corresponding expert or professional.

Matching engine 80 includes a display monitor to display a user-selected profiles identified by lexical elements that are compared and match a first category reference for a license. LIC 1. User selection of lexical elements initiates retrieval and display of the profile text for the selected license, LIC 1; selection of a second category reference initiates retrieval and display of licensing data for any licenses or other credentials held by the selected LIC 1 and an image copy of the document including display of region, in a separate window that corresponds with first category reference. Matching engine 80 may also display and retrieve law suit data such as verdict data related to the expert or a legal professional; and selection of first category reference initiates retrieval and display of documents such as complaints having matching lexical elements from legal database 45b, that are related to, for example where the expert or legal professional has entered an appearance. Other embodiments include additional control features for professional accessing court-filing, documents, such as briefs, and/or expert reports authored by the expert or legal professional, or even deposition and trial transcripts where the expert or professional or testimony was a participant. Still other embodiments provide control features for initiating an Internet search based on the selected expert or professional and other data and for filtering results such search based on the profile of the expert or professional.

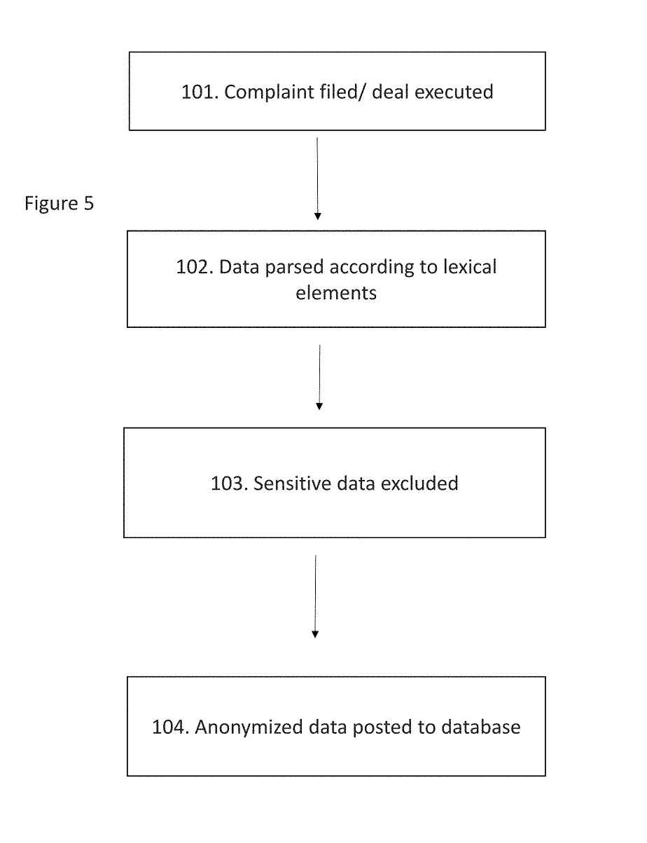

Exemplary methods of operation of the invention will be described with respect to the Figures. FIGS. 5-7 show flow diagrams of exemplary embodiments of the present invention. The flow charts FIGS. 5-7, includes blocks 101-104, 201-204 and 301-306, respectively, which are arranged and described in a serial execution sequence in the exemplary embodiment. However, other embodiments execute two or more blocks in parallel using multiple processors or processor-like devices or a single processor organized as two or more virtual machines or sub processors. Other embodiments also alter the process sequence or provide different functional partitions to achieve analogous results. For example, some embodiments may alter the client-server allocation of functions, such that functions shown and described on the server side are implemented in whole or in part on the client side, and vice versa. Moreover, still other embodiments implement the blocks as two or more interconnected hardware modules with related control and data signals communicated between and through the modules. Thus, this description applies multiple to software, hardware, and firmware implementations.

Turning to FIG. 5, at block 101, the Comparison engine 40 begins with receipt of a document, such as a licensing deal document. This entails receipt of an un-redacted document, such as a patent license agreement. However, as discussed below, other embodiments receive and process other types of documents. Execution then advances to Parser 48, that entails determining the type of document. The exemplary embodiments uses one or more methods for determining document type, for example, the Parser 48 can analyze the document for particular format and syntax and/or keywords to differentiate among sensitive documents having confidentiality clauses or royalty rate data. In some embodiments, type can be inferred from the source of the document or by listing patent numbers. Incoming content types, such as license agreements, have a variety of grammar, syntax, and structural differences that allow for identification. After type (or document description) is determined, the data is parsed or anonymized according to lexical elements at block 102 where the sensitive clauses are extracted under one or more category references from the received document based on the determined type of the document by Extraction engine 50. In the exemplary embodiment, four types of entity records are extracted: organizational names of licensee or licensor companies, product names, such as trademarks for drugs, chemicals and other products; and patent numbers.

Anonymization is defined by any technique, method, algorithms, formulae, code or means involving database anonymization, database sanitization, masking, synthetic data, Statistical Disclosure Control (SDC), Statistical Disclosure Limitation (SDL), Privacy Preserving Data Publishing (PPDP), Privacy Preserving Data Mining (PPDM), microdata anonymization, perturbative masking, non-perturbative masking, threshold-based record linkage, rule-based record linkage, probabilistic record linkage, data de-identification, k-Anonymity modeling, t-Closeness microaggregation, calibration to sensitivity, multivariate microaggregation and individual ranking microaggegation. For more description of such anonymization see, J. Domingo-Ferrer, D. Sanchez, J. Soria-Comas, Database Anonymization, Morgan & Claypool Publishers 2016, incorporated herein by reference. Each such anonymizations may provide ex post or ex ante privacy guarantees. With respect to patent license data, where general principles of anonymization apply to protecting an “individual's” information, in the context of the present invention the “individual's” information is one or all of the patent assignee, patent owner, patent inventor, licensee or licensor information.

Other anonymization methods may include black marker, pure randomization, keyed randomization, grouping, truncation, random shift, enumeration, command name, default selections, begin time, user ID or group ID.

Block 104 entails enriching un-redacted category references using a matching process. In the exemplary embodiment, this enriching process entails operating specific types of data harvesters on the web, other databases, and other directories or lists, to assemble a cache of new relevant profile information for databases, such as sensitive license data. The un-redacted entity records are then matched against the harvested entity records using Bayesian matching. Those that satisfy the match criteria are referred to a quality control process for verification or confirmation prior to addition to the relevant entity directory. The quality control process may be manual, semi-automatic, or fully automatic. For example, some embodiments base the type of quality control on the degree to which the match criteria is exceeded.

Once the sensitive data is extracted and anonymized 104, the remaining document may be gathered in the Remaining Data database 60, where summaries of the licensing deals may be prepared or PDFs of the anonymized data are saved. The anonymized and summarized license data may then be posted to the searchable database 90. Thus, it may be understood that private deal data from license agreements may be opened to subscribers of the Home database 70 and such data may be searched according to category, technology area, SME, royalty rate and various other parameters to determine comparable licensing rates without disclosure of sensitive information.

As well, Parser 48 may rank licensing information. The Parser 48 may gather ranking information from licensors and licensees and include as part of the Remaining Data engine 60. Also, prior to extraction, patent numbers may be analyzed with respect to renewal of annuity data, strength of claims, backward citation analysis and forward citation analysis. Such ranking information will be extracted by the Extraction engine 50, so that the underlying patent number and citations are masked/redacted and only the raw ranking numerics are provided to the searchable database 90.

For example, each licensee/licensor will rate/rank each of the following as 0, 10, 20 or 30 to generate a benchmarking score for each patent/portfolio. The benchmarking may be calculated in order to score the strength of the license, strength of the IP, level of the IP to generate revenue (e.g. the higher the score the more flexibility to generate revenue) as depicted in Table 1 below:

TABLE 1

| | | |
|---|---|---|
| 1. Legal structure of License | 2. Financial Criteria of License | 3. Technology Sector for License |
| A. Exclusivity Clause | A. Royalty calculation | A. Granularity of Field of Use |
| 0 - No clause | 0- No clause | Definition |
| 10- Exclusive | 10- Capped total royalty | 0- No field of use definition |
| 20 - Some portion is exclusive | payment | 10- Loose definition |
| 30 - Non-Exclusive | 20- One time payment | 20 - Detailed definition |
| | 30- Percentage rate or unit rate | 30- definition tracks claims of |
| | for life of patent | majority of patents |
| B. Enforceability | B. Royalty rate | B. Hot Technology |
| 0- No termination clause | 0- No royalty or unit rate | 0- Unrated technology |
| 10- Termination clause but no | 10- Rate is under 3% | 10- Tech sector included in |
| right to sue | 20- Rate is 3-10% | bottom third of NASDAQ |
| 20- Termination clause and | 30- Rate is 10% or higher | composite companies |
| clear definition of licensed | | 20 - Tech sector included in |
| product to allow for right to | | middle third of NASDAQ |
| sue | | composite companies |
| 30- Termination clause and | | 30- Tech sector included in top |
| liquidated damages clause and | | third of NASDAQ composite |
| clear definition of licensed | | companies |
| product | | |
| C. | C. Auditing Capability | 4. Owner's Investment in Patent |
| 0- SEP or lacking clear | 0- No auditing clause | 10- 1^{st} Office Action Allowance |
| definition of SEP | 10 - Audit solely invoices | 20- Patent granted after RCE |
| 10- SEP under SSO with strict | 20- Audit all books and | 30- Patent granted after appeal |
| enforcement policy | records | 10- Paid 1^{st} Annuity (small |
| 20- SEP under SSO with | 30- Audit all books and | entities only) |
| lenient enforcement policy | records and certified financial | 20- Paid 2^{nd} Annuity (small |
| 30 - Non-SEP | statements | entity) |
| | | 30 - Paid 3^{rd} Annuity (small |
| | | entity) |
| | | 40- Filed counterparts in at least 5 |
| | | foreign countries (small entity |
| | | only) |

The Extraction engine can collect the ranking data from licensors and licensees regarding each license and link the ranking data to the extracted data from each license. The categories for ranking including exclusivity clause in license, enforceability clause in license, entanglements issues, royalty rate, royalty calculation clause, auditing clause, hot technology sector, payment of annuity and first office action allowance. The invention provides percentile rank of a raw score interpreted as the percentages of results in the normal group who scored at or below the score of interest to provide a percent rank (PR) that relies on mathematical formula:

PR=((f_{b}+½f_{w})/N)100
f_{b} is the frequency below the number of benchmarks which are less than the benchmark value percentile rank;
f_{w} is the within the number of benchmarks which have the same value as the benchmark value of the percentile rank, and
N is the number of benchmarks,
f_{b} is calculated according to the following formula:
f_{b}=ni/Σni
   Where nᵢ is the frequency of an individual item; and Σnᵢ is the total frequency.

If the distribution is normally distributed, the percentile rank can be inferred from the standard score. Scoring of each benchmark 1 to 1000, based upon percent ranking.

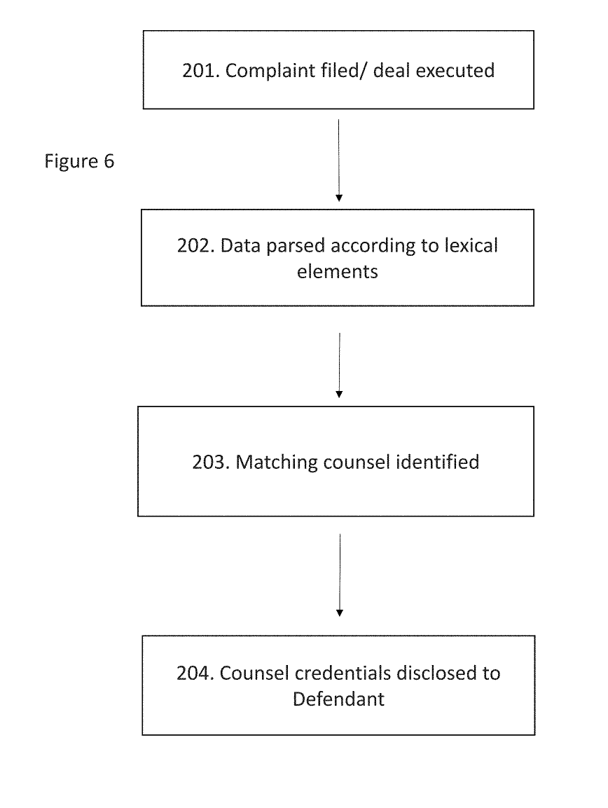

With respect to FIG. 6, block 201 and 202 entail presenting a search interface to a user. In the exemplary embodiment, this entails a user directing a browser in a client access device to internet-protocol (IP) address for an online information-retrieval system, such as Home database 70, and then logging into the system. Successful login results in a display of a web-based search interface being output from server 70/80, and displayed by client access device.

Upon login, the subscriber, usually a lawyer or law firm registers and selects the matter matching service and inputs his/her biographical data including technical experience or degree(s). Execution then advances to block 203 that entails receipt of an automatic query that defines one or more attributes of an entity, such as a legal professional or expert. In some embodiments, the query string includes a set of terms and/or connectors, and in other embodiment includes a natural-language string or lexical elements extracted by the extraction engine 50 from a newly filed lawsuit. In some embodiments, the set of target databases 45a-e is defined automatically or by default based on the form of the system or search interface or lexical elements extracted from the new complaint.

Execution continues at block 204 that entails presenting search results to a named defendant in the new lawsuit via a graphical user interface. In the exemplary embodiment, this entails the server or components under server control or command, executing the query against one or more of databases 45a-e, for example, to identify a summary of matching professional profiles that satisfy the query criteria (but initially excluding the name of the professional). For example, an email is sent with a link to the Home database 70, providing a listing of results that is then presented or rendered as part of a web-based interface for the Defendant so that it may choose highly qualified and experienced counsel. Thereafter additional information may be presented regarding one or more one or more of the listed professionals once the Defendant replies and agrees to the terms of engagement of the matter matching service. In the exemplary embodiment, this entails receiving a request in the form of a user selection of one or more of the professional profiles listed in the search results. These additional results may be displayed. Matching engine interface 80 shows a listing of links from the Home database 70 and additional information related to the selected professional. The Defendant may also subscribe to the service and initiate retrieval and display of a verdict document (or other court records of a selected professional) from Home module interface 70. If the professional that is matched by the Home interface and Matching engine is engaged by the Defendant, the professional will pay the Home interface according to the terms of the subscription agreement.

In FIG. 6, an exemplary method of building a directory is described including the flow diagram shows an exemplary method of building an easily cross referenceable professional or expert directory or database such as used in system. At Comparison module 40, the exemplary method begins with extraction of a first category references from newly filed complaint text documents from lawsuit database 45d, such as PACER. The first category references include type of lawsuit, court where filed, assigned judge and specific technology involved.

The directory is built further with reference to databases 45a-d. In the exemplary embodiment, this entails extracting professional and expert references from jury verdict settlement (JVS) documents that have a consistent structure that includes an expert witness section or paragraph.

The exemplary embodiment uses a Parser engine 48 to locate expert-witness paragraphs and find lexical elements (that is, terms used in this particular subject area) pertaining to an individual having subject matter expertise (SME). These lexical elements include name, degree, area of expertise, organization, city, and state. Parsing a paragraph entails separating it into sentences, and then parsing each element using a separate or specific lexical element.

Typically one expert is listed in a sentence along with his or her area of expertise and other information. If more than one expert is mentioned in a sentence, area of expertise and other elements closest to the name are typically associated with that name. Each JVS document generally lists only one expert witness; however, some expert witnesses are references in more than one JVS document.

Once the category references are defined, execution continues by Extraction engine 50 that merges expert-witness reference records that refer to the same person to create a unique expert-witness profile record for the expert or professional profile. The Extraction engine 50 or Matching engine 80 may then sort the reference records by last name to define a number of last name groups, by SME or technology area. Records within each group are then processed by selecting an unmerged expert or professional reference record and creating an new expert or professional profile record from this selected record. The new reference record is then marked as unmerged and compared to each unmerged reference record in the group using Bayesian matching to compute the probability that the expert in the profile record refers to the same individual referenced in the record. If the computed match probability exceeds a match threshold, the reference is marked as “merged.” If unmerged records remain in the group, the cycle is repeated.

In an embodiment, additional information may be added to the expert and professional reference records. This entails harvesting information from other databases 40a-d, and sources, such as from professional licensing authorities, telephone directories, etc. In determining whether a harvested license record (analogous to a reference record) and expert or professional person refer to the same person, the exemplary embodiment computes a Bayesian match probability based on first name, middle name, last name, name suffix, city-state information, area of expertise, and name rarity. If the match probability meets or exceeds a threshold probability, one or more elements of information from the harvested license record are incorporated into the reference record. If the threshold criteria is not met, the harvested license record is stored in a database for merger consideration with later added or harvested records.

Each expert witness or professional record is assigned one or more classification categories in an expertise or technology taxonomy. Categorization of the entity records allows the Matching engine 80 search expert witness or other professional profiles by area of expertise. To map an expert or professional profile record to an expertise or technology subcategory, the exemplary embodiment uses a categorizer and a taxonomy that contains top-level categories and subcategories.

The exemplary taxonomy includes the following top-level categories: Accident & Injury Accounting & Economics Computers & Electronics; Construction & Architecture; Copyright, Criminal, Fraud and Personal Identity; Employment & Vocational Engineering & Science Environmental; Family & Child Custody; Legal & Insurance Medical & Surgical Property & Real Estate; Patent; Psychiatry & Psychology Vehicles, Transportation, Equipment & Machines; Trademarks. Each category includes one or more subcategories. For example, the “Patent” category has the following subcategories: big data storage systems, cloud services, financial services and securities trading systems, email, internet encryption systems, eCommerce technology, internet mapping systems, internet server systems, mp3 compression, gaming technology, HVAC controllers, low-latency point-to-point communication systems, microwave transmission systems, semiconductor testing systems, charger plug adapters for cell phones, pixel imaging systems, article-writing software, luggage-locking and security systems, optoelectronics, fiber optics, optical connectors, cable assemblies, semiconductor lasers, electromagnetic shielding, wave division multiplexing (WDM) systems, electrical connectors, torque sensors, semiconductor chip sockets, PC cards, position sensors, electrical cables, ethernet communication devices, buss bars, differential signal terminators, automotive safety systems, microwave transmission controllers, LED bulbs and power distribution units.

Assignment of subject-matter categories to an expert or professional profile record entail using a function that maps a professional descriptor associated with the profile to a leaf node in the profile's taxonomy. This function is represented with the following equation: T=ƒ(S) where T denotes a set of taxonomy nodes, and S is the professional descriptor. The exemplary function ƒ uses a lexicon of 500 four-character sets that map professional descriptors to expertise area.

The Matching Engine 80 associates one or more text documents and/or additional data sets with one or more of the professional profiles. To this end, the exemplary embodiment logically associates or links one or more JVS documents to expert-witness profile records using Bayesian based record matching.

To link JVS documents to expert profile records, expert-reference records are extracted from the articles using one or more suitable parsers through parsing and matched to profile records using a Bayesian inference network similar to the profile-matching technology described previously. For JVS documents, the Bayesian network computes match probabilities using seven pieces of match evidence: last name, first name, middle name, name suffix, location, organization, and area of expertise.

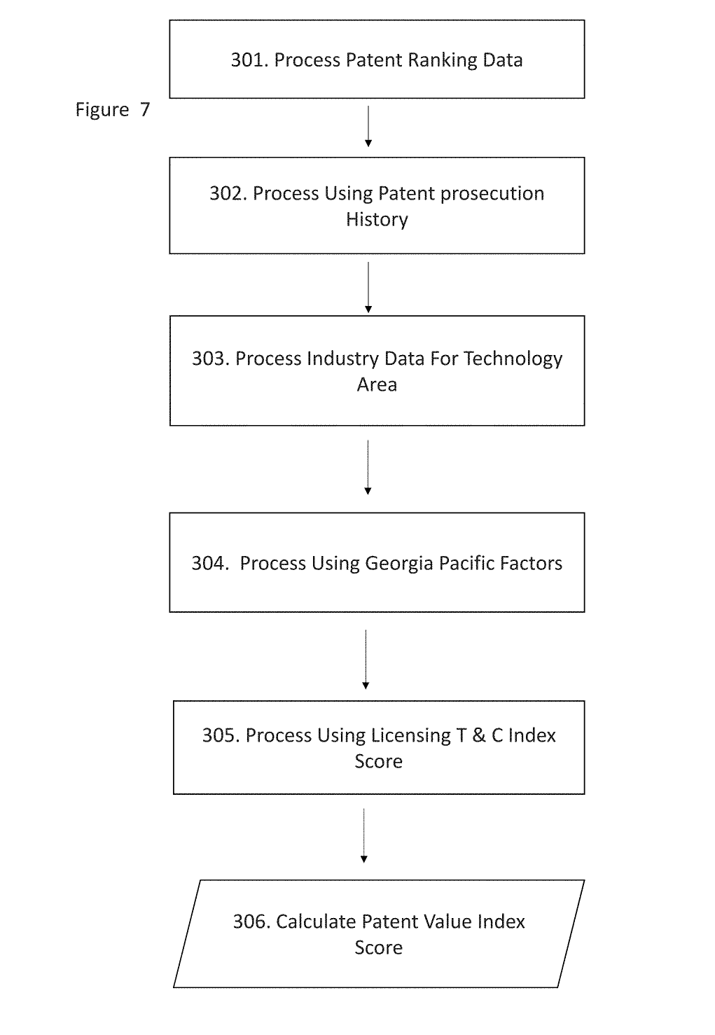

Turning to FIG. 7 in block 301, the patent ranking data is processed by receiving the survey from the custodian as described above with respect to step 33 (FIG. 3). At block 302 the patent prosecution history may be used to process the valuation data. This step should be accomplished based on information provided in the survey data from the custodian. Since the patent number is sensitive data that will be redacted from the valuation data provided to the host of the database, the custodian must provide the ranking score with respect to such patent prosecution information as identified in Table 1 above.

At block 303 industry data by technology area is processed to pair the valuation data with database information 40a-e Then upon identifying the appropriate technology area of the valuation data for a particular license, the ranking data can be processed more accurately using the corresponding ranking data for that specific technology area. To more accurately identify technology area the classification codes of patent offices such as the US Patent and Trademark Office class codes may be used.

At block 304, in some embodiments the valuation data from the searchable database 90 may be analyzed and processed further using the Georgia Pacific factors. One or two of such factors may be used, or all fifteen factors may be used. In an embodiment, algorithms may be provided that correspond to each of the fifteen Georgia Pacific factors in order to computerize and automate the analysis.

At block 305 a licensing term index is provided for processing the cumulative score obtained from the preceding steps 301-304. This index can provide on a scale of 1-1000, for example, the strength of a particular license. In order to rank each individual patent contained in a license, it is important to take each patent with respect to its corresponding license rank in order to normalize the valuation data of each patent/IP right.

Finally at block 306 a patent value index score may be provided according to the ranking methods discussed above in relation to the license term index. The patent value index may also be provided on a scale of 1-1000. The index may be used to calculate a relative royalty rate or value based on the comparable data obtained from the searching of host database 90 (FIG. 4).

The invention may be implemented using block chain 220 is a public ledger that comprises a record of all transactions involving cryptocurrency. Transactions on the block chain 220 are independently verified by the custodian and consumer devices in the online music marketplace 100. As such, in some examples, each custodian device 110, and each consumer device 220, may have a copy of the block chain 220 stored in non-transitory memory. Further, the block chain 220 may expand, as transactions in the online music marketplace 100 continue to occur and be recorded on the block chain 220. After pre-set time intervals, new blocks in the block chain 220 may be published to the block chain, and may be available to each custodian device 110 and consumer device 120 via the network 225. In some examples, the time intervals may be microseconds. As such, in some examples the generation of blocks in the block chain 220 may be approximately automatic. In other examples, the time intervals may be seconds. In still further examples, the time intervals may be approximately 1 minute. In other examples the time intervals may be in a range between 1 microsecond and 5 minutes. Thus, after the pre-set time intervals (e.g., 5 microseconds) since the most recent creation of a block, a new block may be created in the block chain 220. Each block in the block chain 220 may comprise information regarding transactions performed in the time since the most recent block in the block chain 220. Thus, all transactions are recorded in a block of the block chain 220, which may be stored on each custodian device 110 and consumer device 120 in the online music marketplace 100. Said another way, a transaction is part of a new block in the block chain 220, which records a transfer of ownership of cryptocurrency. Thus, in some examples, a transaction includes a recording in the block chain 220, of a new public key to which cryptocurrency is assigned. Thus, the ownership of cryptocurrency may be known by all artist and consumer devices in wired and/or wireless communication with network 225, since during a transfer of ownership, the new or current public key address of that cryptocurrency is published on the block chain 220.

The embodiments described above are intended only to illustrate one or more ways of practicing or implementing the present invention, not to restrict its breadth or scope. The actual scope of the invention is defined only by their equivalents appended hereto.

The invention claimed is:

1. A system for anonymizing license data comprising:
a first database including a set of records;
a parser module to identify one or more lexical elements contained within a license document;
a comparison module adapted to compare a first category reference against the lexical elements; and
an extraction module adapted to extract the first category reference from the document based at least in part on the lexical elements wherein the first category reference contains sensitive license information.

2. The system of claim 1, comprising the first category reference comprising sensitive license information including one or more of patent number, assignee name, inventor name and owner name.

3. The system of claim 1, wherein the set of records include one or more of legal records from PACER, Linked-In or licensing records from licensing organizations.

4. The system of claim 1 further comprising an extraction engine for collecting ranking information from one of the following categories including exclusivity clause in license, enforceability clause in license, entanglements issues, royalty rate, royalty calculation clause, auditing clause, hot technology sector, payment of annuity and first office action allowance.

5. The system of claim 1 wherein the ranking is applied in a manner to identify the most flexibility for generation of maximum royalties using a numeric scale assigned to sub-categories.

6. The system of claim 5 wherein the sub-categories include one of an Exclusivity Clause: no clause, exclusive, some portion is exclusive, non-exclusive; Enforceability clause: no termination clause, termination clause but no right to sue, Termination clause and clear definition of licensed product to allow for right to sue, Termination clause and liquidated damages clause and clear definition of licensed product; Entanglements: Standard Essential Patent (SEP) or lacking clear definition of SEP, SEP under Standard Setting Organization (SSO) rules with strict enforcement policy, SEP under SSO with lenient enforcement policy, Non-SEP; Royalty calculation: no clause, Capped total royalty payment, One time payment, Percentage rate or unit rate for life of patent; royalty: No royalty or unit rate, Rate is under 3%, Rate is 3-10%, Rate is higher than 10%; Auditing Capability: No auditing clause, Audit solely invoices, Audit all books and records, Audit all books and records and certified financial statements; Granularity of Field of Use Definition: No field of use definition, Loose definition; Detailed definition; definition tracks claims of majority of patents; Hot Technology: unrated technology, Technology sector included in bottom third of NASDAQ composite companies, Technology sector included in middle third of NASDAQ composite companies, Technology sector included in top third of NASDAQ composite companies; Strength of Patent: 1^{st} Office Action Allowance, Patent granted after Request for Continued Examination, Patent granted after appeal, Paid 1^{st} Annuity (small entities only), Paid 2^{nd} Annuity (small entity only), Paid 3^{rd} Annuity (small entity only), Filed counterparts in at least 5 foreign countries (small entity only).

7. The system of claim 1 wherein ranking is provided as a percent rank.

8. The system of claim 1 wherein the anonymization includes one of database anonymization, database sanitization, masking, synthetic data, Statistical Disclosure Control (SDC), Statistical Disclosure Limitation (SDL), Privacy Preserving Data Publishing (PPDP), Privacy Preserving Data Mining (PPDM), microdata anonymization, perturbative masking, non-perturbative masking, threshold-based record linkage, rule-based record linkage, probabilistic record linkage, data de-identification, k-Anonymity modeling, t-Closeness microaggregation, calibration to sensitivity and multivariate microaggregation and individual ranking microaggegation.

9. A method for anonymizing a document comprising the steps of:
detecting a characterization label of an entity who is a party to a contested proceeding;
obtaining a set of data comprising entities, each entity being associated with one or more features related to the entity and a characterization label indicating a characterization of the entity, the characterization labels comprising an operating company label and a patent monetizing entity label; and
using at least some of the one or more features of the entities and the characterization labels to train a classifier for predicting the characterization label of an entity in a contested proceeding; and
using the label data to compare to law firm label data in order to identify law firms with matching label data.

10. The method of claim 9, wherein the lexical elements include one or more of person's name, degree, area of expertise, organization, city, state, license, professional designations or certifications, title, work experience, university, patent number, inventor name, assignee name, technology category, classification number, filing date, issuance date, publication date and license information including number of patents, exclusivity, standard essentiality, scope and royalty rate.

11. The method of claim 9, comprising a second category reference comprising professional information including one or more of a person's name, title, license, degree, professional designation, work experience, court appearances, firm name.

12. The method of claim 9, comprising a first match code set adapted to determine whether the second category reference matches any records contained in the set of harvested entity records and saving the matched records.

13. The method of claim 9, further comprising disclosing the matched records to defendants listed in a lawsuit.

14. The method of claim 9, wherein the second category reference includes professional records associated with one or more of the following fields: type of legal dispute, judge name, court name, law firm name, financial result, motion results, trial experience, trial results, legal subcategory of pharmaceutical, accounting, engineering, healthcare, medical, scientific, and educational.

15. The method of claim 9, wherein the first match code set includes executable instructions for performing one or more of a Bayesian function, a match probability function, and a name rarity function.

16. The method of claim 9, wherein one or both of the first and second match code sets includes executable instructions for satisfying a threshold match probability criteria prior to extraction.

17. The method of claim 9 further comprising the parsing engine for harvesting professional credentials that match first category references to lexical elements of professionals listed in notice section of document and disclosing credential information to defendant listed in newly filed complaint.

18. The method of claim 9, further comprising the step of:
applying anonymizing tool to the licensing data to remove sensitive information from each license and creating a counterpart synthetic license document having the sensitive data removed and wherein anonymizing includes one of masking, de-identifying, obsfucating and randomizing the licensing data.

19. The method of claim 18, wherein conditional entropy H(Φ|Q) is calculated according to the equation: H(ΦQ)=−Σi=1VPc(i)·log 2Pc(i), wherein V is the number of possible values for user identity Φ and wherein P_{c}(i) is the posterior probability of identity value, given Q.

20. A method for anonymizing licensing data comprising the steps of:
loading license data to a central file;
applying the anonymizing tool to the licensing data to remove sensitive information from each license;
creating a counterpart synthetic license document having the sensitive data removed;
loading license data from each counterpart synthetic license to a relational database and enabling searching of predetermined fields of the license data; and
a director anonymizes the licensing data where the director applies a template in order to remove predetermined sensitive data including patent numbers, licensor name and address and licensee name and address wherein the numeric benchmark values are derived by a percentile rank via the percent ranking module according to the following formula: PR=fb+12fwN*100 where PR is the percent rank; f_{b} is the frequency below the number of benchmarks which are less than the benchmark value percentile rank; f_{w} is the frequency within the number of benchmarks which have the same value as the benchmark value of the percentile rank; N is the number of benchmarks; and relative frequency is calculated according to the following formula: fb=niΣni where f_{b} is the frequency below the number of benchmarks which are less than the benchmark value percentile rank; and n is the number of benchmarks.
